(19) United States
(12) Patent Application Publication
(10) Pub. No.: US 2026/0236397 A1
(43) Pub. Date: Aug. 13, 2026

(54) SYSTEM AND METHOD FOR WEBASSEMBLY MEMORY MANAGEMENT

(71) Applicant: TOYOTA JIDOSHA KABUSHIKI KAISHA, Toyota-shi (JP)

(72) Inventors: Jean-François BASTIEN, Tokyo (JP); Caleb McGary, Shinjuku-ku (JP)

(73) Assignee: TOYOTA JIDOSHA KABUSHIKI KAISHA, Toyota-shi (JP)

(21) Appl. No.: 19/219,078

(22) Filed: May 27, 2025

Related U.S. Application Data
(60) Provisional application No. 63/756,881, filed on Feb. 11, 2025.

(51) Int. Cl. G06F 12/08; G06F 9/455; G06F 11/07

(52) U.S. Cl. CPC G06F 12/08; G06F 9/45529; G06F 11/073

(57) ABSTRACT

Provided are system, method, and device for automatically manage WebAssembly memory. According to example embodiments, the system may include: a memory storage storing computer-executable instructions; and at least one processor communicatively coupled to the memory storage, wherein the at least one processor may be configured to execute the instructions to: obtain a WebAssembly (wasm) code comprising a programming code; virtually allocate, to the wasm code, a memory space comprising a primary memory region and a red zone region in a single call; generate a sandbox environment containing the wasm code based on the allocated memory space; execute the wasm code within the sandbox environment; detect a fault caused by execution of the wasm code; and in response to detecting the fault, halt execution of the wasm code.

### CROSS-REFERENCE TO RELATED APPLICATIONS

This application claims priority from US Provisional Patent Application No. 63/756,881, filed with the United States Patent and Trademark Office on Feb. 11, 2025, the disclosure of which is incorporated herein by reference in its entirety.

### TECHNICAL FIELD

Example embodiments of the present disclosure relate to WebAssembly, and more specifically, relate to the management of memory of the WebAssembly.

### BACKGROUND

WebAssembly (wasm) refers to a binary instruction format designed to serve as a portable compilation target for high-level programming languages, and enable deployment on a website for client and server applications.

In particular, programming codes may be written in their respective languages and compiled into the wasm format, where the compiled programming codes in the wasm format may be delivered to and executed in any modern web applications/browsers. It provides a compact, efficient, and secure execution model that allows codes to run at near-native speeds by leveraging existing hardware capabilities.

Wasm is also widely adopted for its ability to safely execute codes from multiple languages in a sandboxed environment, enhancing performance and security for web applications.

This technology has also been increasingly utilized in diverse domains beyond the web, such as gaming, server-side applications, and Internet of Things (IoT) devices, making efficient memory management a critical component for its successful implementation. Wasm may also be utilized in the context of vehicles, to support secure sandboxing as well as portability.

### SUMMARY

Example embodiments consistent with the present disclosure allow for improvements in time requirements and efficiency for wasm memory allocation.

According to example embodiments, a system is provided. The system may include: a memory storage storing computer-executable instructions; and at least one processor communicatively coupled to the memory storage, wherein the at least one processor may be configured to execute the instructions to: obtain a WebAssembly (wasm) code comprising a programming code; virtually allocate, to the wasm code, a memory space comprising a primary memory region and a red zone region in a single call; generate a sandbox environment containing the wasm code based on the allocated memory space; execute the wasm code within the sandbox environment; detect a fault caused by execution of the wasm code; and in response to detecting the fault, halt execution of the wasm code.

According to example embodiments, the fault may be detected in response to the wasm code attempting to access the red zone region of the allocated memory space during execution of the wasm code.

According to example embodiments, the allocated memory space may be tracked using a special-casing wasm memory allocation tracking information.

According to example embodiments, the system may include an operating system (OS).

According to example embodiments, the memory space may be allocated at an address space layout randomization (ASLR) location.

According to example embodiments, the memory region of the memory space may include 4GiB space.

According to example embodiments, the fault may include segmentation fault.

According to example embodiments, a method is provided. The method may include: obtaining a WebAssembly (wasm) code comprising a programming code; virtually allocating, to the wasm code, a memory space comprising a primary memory region and a red zone region in a single call; generating a sandbox environment containing the wasm code based on the allocated memory space; executing the wasm code within the sandbox environment; detecting a fault caused by execution of the wasm code; and in response to detecting the fault, halting execution of the wasm code.

According to example embodiments, the fault may be detected in response to the wasm code attempting to access the red zone region of the allocated memory space during execution of the wasm code.

According to example embodiments, the allocated memory space may be tracked using a special-casing wasm memory allocation tracking information.

According to example embodiments, the method may be performed by an operating system (OS).

According to example embodiments, the memory space may be allocated at an address space layout randomization (ASLR) location.

According to example embodiments, the memory region of the memory space may include 4GiB space.

According to example embodiments, the fault may include segmentation fault.

According to example embodiments, a non-transitory computer-readable recording medium is provided. The non-transitory computer-readable recording medium may have recorded thereon instructions executable by at least one processor to cause the at least one processor to perform a method including: obtaining a WebAssembly (wasm) code comprising a programming code; virtually allocating, to the wasm code, a memory space comprising a primary memory region and a red zone region in a single call; generating a sandbox environment containing the wasm code based on the allocated memory space; executing the wasm code within the sandbox environment; detecting a fault caused by execution of the wasm code; and in response to detecting the fault, halting execution of the wasm code.

According to example embodiments, the fault may be detected in response to the wasm code attempting to access the red zone region of the allocated memory space during execution of the wasm code.

According to example embodiments, the allocated memory space may be tracked using a special-casing wasm memory allocation tracking information.

According to example embodiments, the method may be performed by an operating system (OS).

According to example embodiments, the memory space may be allocated at an address space layout randomization (ASLR) location.

According to example embodiments, the memory region of the memory space may include 4GiB space.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a flow diagram of an example method for managing WebAssembly memory, according to one or more example embodiments;

FIG. 2 illustrates an example memory space, according to one or more example embodiments;

FIG. 3 illustrates an example pseudo code for virtually allocating a memory space to a wasm code, according to one or more example embodiments;

FIG. 4 illustrates an example pseudo code for bumping virtual allocation a memory space to a wasm code, according to one or more example embodiments;

FIG. 5 illustrates an example pseudo code for freeing an allocated memory, according to one or more example embodiments; and

FIG. 6 illustrates a block diagram of example components in a system, according to one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

As described above, WebAssembly (wasm) serves as a portable compilation target for high-level programming languages, and enables safe execution of codes from multiple languages in a sandboxed environment.

In the related art, implementation of wasm to contain execution of untrusted software in the sandboxed environment may involve performing bound checks on every access from the untrusted software. However, such process may be difficult and onerous.

To alleviate the above issue, solutions have been proposed which involve ensuring that memory access from the untrusted software stays within the sandbox environment. Specifically, a large amount of memory may be allocated to the untrusted software in the sandboxed environment, where the hardware is expected to fault on invalid access performed by the untrusted software.

In order to allocate the memory as described above, memory allocation may need to be requested (system call) from an operating system first. Such request may be done one at a time through functions, such as mmap and mprotect, requesting page-granularity allocations on the operating system. With each request, the operating system may perform bookkeeping and record the requests in its data structures or in hardware-known pagetable translation lookaside buffer (TLB).

In this regard, since operating system may record each request, the operating system may need to maintain an evolving data structure, which will continuously grow larger and be more expensive to maintain under standard implementations. This also means that the allocation of memory is time consuming, sub-optimal, and inefficient.

Accordingly, there is a need for a system for memory management that improves the memory allocation process described above.

It is contemplated that features, advantages, and significances of example embodiments described herein are merely a portion of the present disclosure, and are not intended to be exhaustive or to limit the scope of the present disclosure. Further descriptions of the features, components, configuration, operations, and implementations of the example embodiments of the present disclosure are provided in the following.

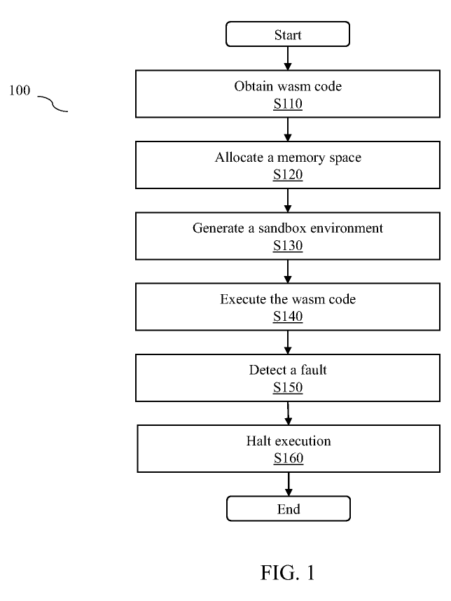

FIG. 1 illustrates a flow diagram of an example method 100 for managing WebAssembly memory, according to one or more example embodiments. One or more operations in method 100 may be performed by at least one processor (e.g., processor 612) of a system.

Here, the system may include an apparatus, a system, a platform, a module, or the like, which may be configured to perform one or more operations or actions for managing WebAssembly memory.

According to example embodiments, the system may include an operating system (OS). The OS here may include any kind of operating systems (e.g., UNIX-like operating system, windows operating system, mac operating system, berkeley software distribution (BSD) operating system, QNX operating system, real-time operating system (RTOS), etc.), hypervisors, bare-metal execution environments, containers, sandboxing mechanisms, and the like.

According to example embodiments, the system may also include a hardware which the OS is operating on. The hardware may include machines with 64-bit pointers (e.g., including a wide accelerated processing unit (APU)). Such hardware that supports 64-bit pointers may enable allocation of 4GiB memory space as described below.

According to example embodiments, the system (e.g., the OS) may be configured to host a sandbox environment containing WebAssembly (wasm) code.

The wasm code may include an executable programming code, which may be in a WebAssembly format.

Further, the sandbox environment may refer to an isolated, controlled virtual space, in which programming codes/applications (e.g., the wasm code) may be safely executed without affecting the OS and other programs. The sandbox environment may have allocated resources (memory, system calls, etc.) which are isolated and utilized to host and execute the programming codes. As such, the isolated resources may ensure that any malicious or buggy behavior within the sandbox environment caused by the programming codes do not harm the OS and the underlying system.

As illustrated in FIG. 1, at operation S110, the at least one processor may be configured to obtain a WebAssembly (wasm) code. The wasm code may include an executable programming code, which may be in a WebAssembly format.

The wasm code may be obtained using any means, such as being imported from a WebAssembly development environment, being downloaded via internet through a web browser, and the like. The method then proceeds to operation S120.

At operation S120, the at least one processor may be configured to virtually allocate a memory space to the wasm code. The memory space may include a memory region and a red zone region.

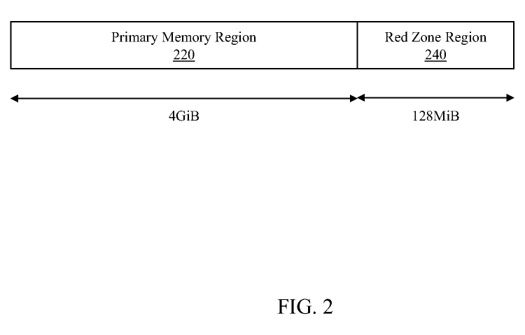

FIG. 2 illustrates an example memory space, according to one or more example embodiments. As shown in FIG. 2, the memory space may include a primary memory region 220 which is followed by a red zone region 240.

The primary memory region 220 may specify an amount of memory (i.e., size) which the wasm code may be permitted to utilize in the sandbox environment.

According to example embodiments, the primary memory region 220 may include 4GiB space. The 4GiB space of the primary memory region 220 may enable alignment with a 4GiB multiple to encode information in the alignment bits.

The red zone region 240 may specify an amount of memory (i.e., size) acting as guard pages, which the wasm code may not be permitted to utilize in the sandbox environment. According to example embodiments, the OS may set the guard pages (red zone region 240) as inaccessible, such that should the wasm code attempt to access (read/write) the guard pages, faults may be triggered and detected, as further described below in relation to operation S150.

In the example shown in FIG. 2, the primary memory region 220 may include 4GiB space while the red zone region 240 may include 128MiB space (such that the total allocated memory space is around 4.128GiB), although it is understood that the present disclosure is not limited thereto and can encompass any value for the sizes of the primary memory region 220 and the red zone region 240.

According to example embodiments, the memory space (including both the primary memory region and the red zone region) may be allocated to the wasm code in a single call. According to example embodiments, the single call allocation of the memory space may be performed during startup/execution of the wasm code (e.g., at the same time as operation S140).

In his regard, according to example embodiments, the allocated memory space may be tracked using a special-casing wasm memory allocation tracking information. In particular, according to example embodiments, the at least one processor may be further configured to track (i.e., record) the single call allocation of the memory space in a special-casing WebAssembly memory allocation tracking information. The special-casing WebAssembly memory allocation tracking information may include information associated with the single call allocation of the memory space, such as memory location, protection status, and the like.

The special-casing WebAssembly memory allocation tracking information may be helpful in identifying various information should a fault be detected (e.g., during operation S150 below), such as which memory location is affected, what is protection status, and the like.

In this regard, by allocating the memory space in a single call and tracking such allocation in the special-casing WebAssembly memory allocation tracking information, the overall amount of tracking to be done as well as the size of data structure that maintains the tracking information may be reduced.

According to example embodiments, the memory space may be allocated at an address space layout randomization (ASLR) location. The ASLR location may refer to a location within a memory of the system, which is randomized.

As such, by allocating the memory space at the ASLR location, if the wasm code includes a malicious software, such software trying to breakout of the sandbox environment may be prevented from finding a reproducible location within which the sandbox environment operates, making the breakout more difficult because it is less predictable.

Further, the ASLR can allow the sandbox environment to be allocated at any valid virtual address, which on a 64-bit system with 48-bit of addressable memory may allow for at least 65,536 locations at which an aligned 4GiB allocation could be located.

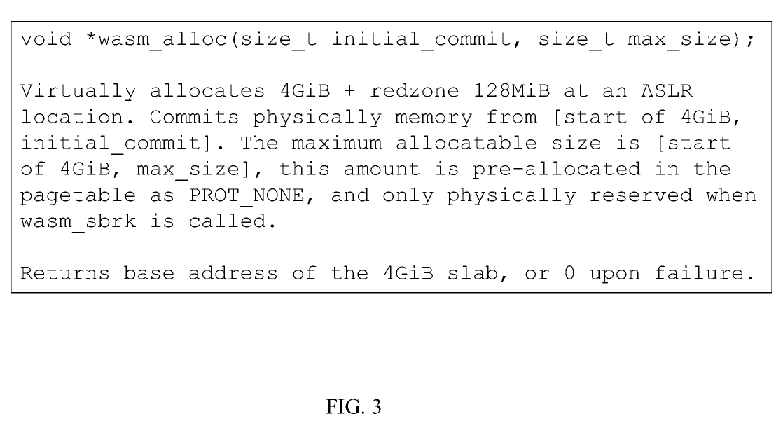

FIG. 3 illustrates an example pseudo code for virtually allocating a memory space to a wasm code, according to one or more example embodiments. According to example embodiments, the pseudo code in FIG. 3 may be implemented as a system call (e.g., functions, etc.)

As shown in FIG. 3, the virtual allocation of a memory space to a wasm code may involve allocating 4GiB space for primary memory region and 128Mib space for red zone region at an ASLR location. The memory may be committed physically from the start of the 4GiB space of primary memory region up to a value defined by “initial_commit”.

Further, the maximum allocatable size of the memory may be the size from the start of the 4GiB space of primary memory region up to a value defined by “max_size”. This amount may be pre-allocated in a pagetable defined as “PROT_NONE”, and may be physically reserved when a function “wasm_sbrk” is called.

Furthermore, the base address of the 4GiB slab (i.e., primary memory region) may be returned if successful. Otherwise, 0 may be returned if failed.

According to example embodiments, the allocation of the memory space may be bumped at runtime in contiguous amounts.

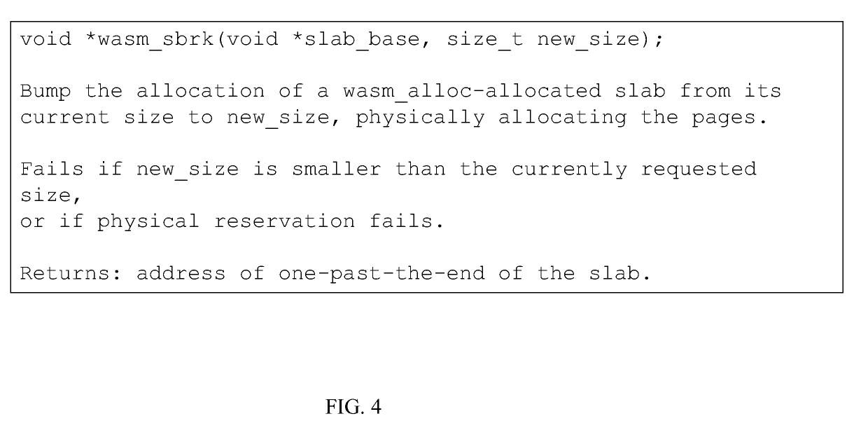

FIG. 4 illustrates an example pseudo code for bumping virtual allocation a memory space to a wasm code, according to one or more example embodiments.

As shown in FIG. 4, the allocation a memory space to a wasm code may be bumped from the current size to a new size, while physically allocating the pages.

If the new size is smaller than the current size or if the physical reservation of the memory space fails, the bumping may fail. Otherwise, the address of the memory space at one cell after the end of the allocated memory space may be returned. The method then proceeds to operation S130.

At operation S130, the at least one processor may be configured to generate a sandbox environment containing the wasm code based on the allocated memory space.

In particular, the sandbox environment may be generated with the wasm code contained within, where the sandbox environment may be allocated with the allocated memory space for hosting and execution of the wasm code within the sandbox environment. The method then proceeds to operation S140.

At operation S140, the at least one processor may be configured to execute the wasm code within the sandbox environment.

According to example embodiments, the wasm code may be executed within the sandbox environment while utilizing the allocated memory space.

Accordingly, the wasm code executed within the sandbox environment utilizing the allocated memory space may be separated from the host runtime, where potential errors or failures may be confined within the isolated sandbox environment, preventing them from spreading to the rest of the system. The method then proceeds to operation S150.

At operation S150, the at least one processor may be configured to detect a fault caused by execution of the wasm code (i.e., the execution of the wasm code within the sandbox environment during operation S140).

According to example embodiments, the fault may include a failure condition raised by the hardware of the system. The failure condition may notify the OS that the wasm code has attempted to access a restricted area of memory.

In this regard, according to example embodiments, the fault may be detected in response to the wasm code attempting to access the red zone region of the allocated memory space during execution of the wasm code during operation S140.

According to example embodiments, the fault may include a segmentation fault. The method then proceeds to operation S160.

At operation S160, in response to detecting the fault, the at least one processor may be configured to halt execution of the wasm code.

According to example embodiments, the processor also may be configured to terminate the sandbox environment alongside the wasm code within.

According to example embodiments, the processor also may be configured to free the allocated memory in response to terminate the sandbox environment alongside the wasm code within.

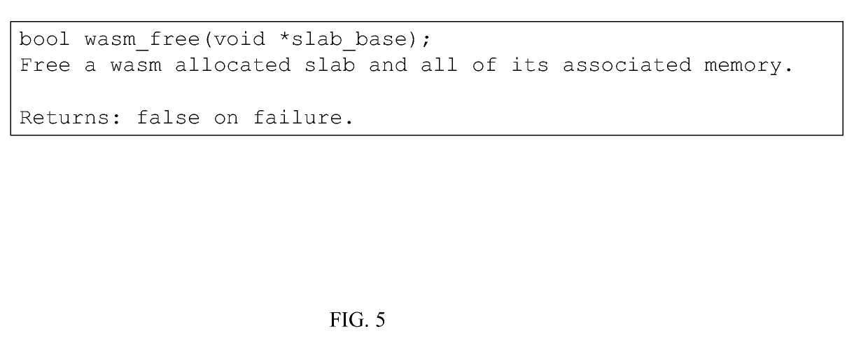

FIG. 5 illustrates an example pseudo code for freeing an allocated memory, according to one or more example embodiments.

As shown in FIG. 5, any associated memory that has been allocated to the wasm code may be freed. In the event that this fails, failure may be returned.

Accordingly, the execution of the wasm code may be halted, which prevents malicious or faulty behavior of the wasm code from continuing and spreading to other parts of the system.

Upon performing operation S160, the method 100 may be ended or be terminated. Alternatively, method 100 may return to operation S110, such that the at least one processor may be configured to repeatedly perform, for at least a predetermined amount of time, the obtaining the wasm code (at operation S110), the virtually allocating the memory space (at operation S120), the generating the sandbox environment (at operation S130), the executing the wasm code (at operation S140), the detecting the fault (at operation S150), and the halting the execution (at operation S160).

Accordingly, the above processes improve overall time requirements and efficiency for wasm memory allocation.

In particular, as described above, the allocation of memory space for wasm code in the related art may involve requesting allocation one at a time, with each request increasing the size of the data structure maintained by the OS to keep track of the allocation.

Here, performing multiple requests/system calls are expensive and time consuming. On a real-time operating system, a system call is also often blocking until it completes which can impact other actions of the system. For this reason, it is desirable to reduce the number of request/calls to the bar minimum (e.g., in a single call) and ideally done at startup of the application.

Further, the metadata that is used to track memory allocations can be expensive if it tracks each sub-allocation. The above processes allow tracking of sub-allocation to be done more succinctly, which results in reduced memory usage and time to handle metadata manipulation. This may be important when shared memory is used for communication between an A-Core (Application Core) and an R-Core (RealTime Core), since it may be desirable to determine the maximum upper bound of memory usage for communication via shared memory. It is noted that, for ROTS, this may simply be fixed size.

Furthermore, for certain OS, such as RTOS, it may be important to provide determinism. The above processes allow the ROTS to avoid pathologies caused by metadata book-keeping, which makes it possible to use technologies such as WebAssembly in an RTOS.

Ultimately, example embodiments of the present disclosure enable safe execution of unknown codes (i.e., wasm code) within sandbox environment of an operating system, where execution of the unknown codes may be halted when the unknown codes attempts to access restricted portion of the allocated memory and triggers a fault, while also allow the allocation of the memory for the unknown codes within thendbox environment to be performed in a quick and efficient manner.

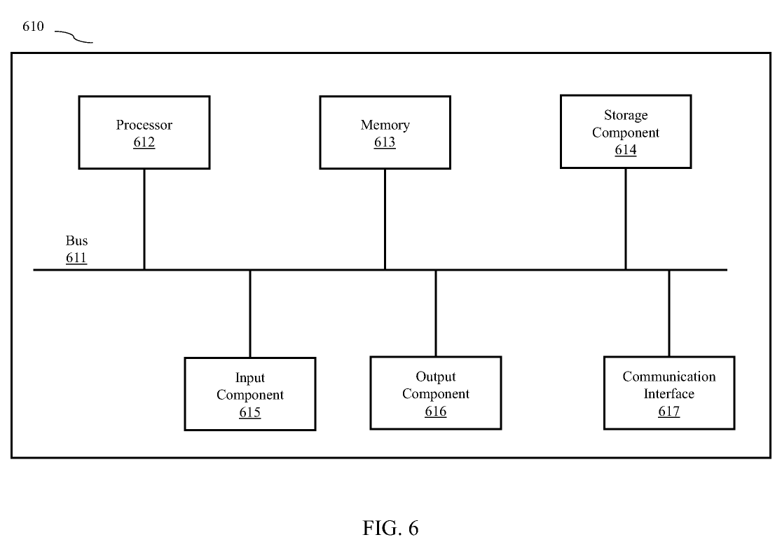

FIG. 6 illustrates a block diagram of example components in a system 610, according to one or more example embodiments. The system 610 may correspond to the system described above in relation to FIG. 1, thus the features associated with the system in FIG. 1 and the system 610 may be similarly applicable to each other, unless being explicitly described otherwise.

As illustrated in FIG. 6, the system 610 may include at least one bus 611, at least one processor 612, at least one memory 613, at least one storage component 614, at least one input component 615, at least one output component 616, and at least one communication interface 617.

It is contemplated that the system 610 may include more or less components than illustrated in FIG. 6, without departing from the scope of the present disclosure. For instance, in some embodiments, the system 610 may include a plurality of storage components 614, the input component 615 and the output component 616 may be implemented as a transceiver component, the memory 613 and storage component 614 may be implemented as a memory storage, and the like.

The bus 611 may be configured to facilitate or enable communications among the components of the system 610. Specifically, the bus 611 may communicatively couple the components to each other and provide a means for data transfer and flow of control signals between the components. The bus 611 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 610 to enable communication and coordination between the components within the system 610 in real-time (or near real-time).

The processor 612 may be implemented in hardware, firmware, or a combination of hardware and software, and may be configured to handle real-time (or near real-time) data processing and control of the control system 610. The processor 612 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 610. In some implementations, the processor 612 may be capable of being programmed to perform one or more operations described herein. Further, the processor 612 may include a plurality of processing units, each of which is dedicated to performing a specific operation.

The memory 613 may include one or more mediums for storing temporary data, runtime variables, program instructions, and buffers required for the operations of the control system 610. The memory 613 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 610 to store information and/or instructions for use by the processor 612.

The storage component 614 may be configured to store non-volatile data, such as firmware, configuration settings, calibration data, information, and/or software related to the operation and use of the system 610. For example, the storage component 614 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to example embodiments, the storage component 614 may be configured to store computer-readable or computer-executable instructions for implementing one or more operations of the system 610. The storage component 614 may provide the stored information to the memory 613 for the execution of the processor 612.

The input component 615 may include one or more input components that permit the system 610 to receive information, such as via user input (e.g., a touch screen display, a keyboard, a keypad, a mouse, a button, a switch, and/or a microphone). The output component 616 may include one or more output components that provide output information from the system 610 (e.g., a display, a speaker, a navigation device, one or more light-emitting diodes (LEDs), etc.) According to example embodiments, the input component 615 and/or the output component 616 may be optional and may be excluded from the system 610.

The at least one communication interface 617 may include a transceiver-like component (e.g., a transceiver and/or a separate receiver and transmitter) that enables the system 610 to communicate with other components (e.g., ECUs, user devices, etc.), such as via a wired connection, a wireless connection, or a combination of wired and wireless connections. For example, communication interface 617 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 617 may include at least one input/output (I/O) interface, at least one network interface, at least one storage interface, or the like, that enable the components 612-616 to communicate with other components. Further, the communication interface 617 may include one or more application programming interfaces (APIs) that allow the system 610 (or one or more components included therein) to communicate with one or more software applications (e.g., software application deployed in the ECUs, etc.)

Computer-executable instructions (e.g., software instructions, etc.) may be read into memory 613 and/or storage component 614 from another computer-readable medium or from another device (e.g., a remote server, an external storage, etc.) via, for example, the communication interface 617. When executed, the computer-executable instructions stored in memory 613 and/or storage component 614 may cause the processor 612 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/ flowcharts disclosed herein is an illustration of example approaches. Based upon design preferences, it is understood that the specific order or hierarchy of blocks in the processes/ flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor ). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A system comprising:
a memory storage storing computer-executable instructions; and
at least one processor communicatively coupled to the memory storage, wherein the at least one processor is configured to execute the instructions to:
obtain a WebAssembly (wasm) code comprising a programming code;
virtually allocate, to the wasm code, a memory space comprising a primary memory region and a red zone region in a single call;
generate a sandbox environment containing the wasm code based on the allocated memory space;
execute the wasm code within the sandbox environment;
detect a fault caused by execution of the wasm code; and
in response to detecting the fault, halt execution of the wasm code.

2. The apparatus according to claim 1, wherein the fault is detected in response to the wasm code attempting to access the red zone region of the allocated memory space during execution of the wasm code.

3. The apparatus according to claim 1, wherein the allocated memory space is tracked using a special-casing wasm memory allocation tracking information.

4. The apparatus according to claim 1, wherein the system comprises an operating system (OS).

5. The apparatus according to claim 1, wherein the memory space is allocated at an address space layout randomization (ASLR) location.

6. The apparatus according to claim 1, wherein the memory region of the memory space comprises 4GiB space.

7. The apparatus according to claim 1, wherein the fault comprises segmentation fault.

8. A method comprising:
obtaining a WebAssembly (wasm) code comprising a programming code;
virtually allocating, to the wasm code, a memory space comprising a primary memory region and a red zone region in a single call;
generating a sandbox environment containing the wasm code based on the allocated memory space;
executing the wasm code within the sandbox environment;
detecting a fault caused by execution of the wasm code; and
in response to detecting the fault, halting execution of the wasm code.

9. The method according to claim 8, wherein the fault is detected in response to the wasm code attempting to access the red zone region of the allocated memory space during execution of the wasm code.

10. The method according to claim 8, wherein the allocated memory space is tracked using a special-casing wasm memory allocation tracking information.

11. The method according to claim 8, wherein the method is performed by an operating system (OS).

12. The method according to claim 8, wherein the memory space is allocated at an address space layout randomization (ASLR) location.

13. The method according to claim 8, wherein the memory region of the memory space comprises 4GiB space.

14. The method according to claim 8, wherein the fault comprises segmentation fault.

15. A non-transitory computer-readable recording medium having recorded thereon instructions executable by at least one processor to cause the at least one processor to perform a method comprising:
obtaining a WebAssembly (wasm) code comprising a programming code;
virtually allocating, to the wasm code, a memory space comprising a primary memory region and a red zone region in a single call;
generating a sandbox environment containing the wasm code based on the allocated memory space;
executing the wasm code within the sandbox environment;
detecting a fault caused by execution of the wasm code; and
in response to detecting the fault, halting execution of the wasm code.

16. The non-transitory computer-readable recording medium according to claim 15, wherein the fault is detected in response to the wasm code attempting to access the red zone region of the allocated memory space during execution of the wasm code.

17. The non-transitory computer-readable recording medium according to claim 15, wherein the allocated memory space is tracked using a special-casing wasm memory allocation tracking information.

18. The non-transitory computer-readable recording medium according to claim 15, wherein the method is performed by an operating system (OS).

19. The non-transitory computer-readable recording medium according to claim 15, wherein the memory space is allocated at an address space layout randomization (ASLR) location.

20. The non-transitory computer-readable recording medium according to claim 15, wherein the memory region of the memory space comprises 4GiB space.
